(19) United States
(12) Patent Application Publication
(10) Pub. No.: US 2021/0153125 A1
(43) Pub. Date: May 20, 2021

(54) STATION (STA), ACCESS POINT (AP) AND METHODS TO INDICATE A RESTRICTION OF CONTENTION BASED ACCESS

(71) Applicant: Intel IP Corporation, Santa Clara, CA (US)

(72) Inventor: Laurent Cariou, Portland, OR (US)

(21) Appl. No.: 16/627,928

(22) PCT Filed: Dec. 22, 2017
(86) PCT No.: PCT/US2017/068304

§ 371 Date: Dec. 31, 2019

Related U.S. Application Data
(60) Provisional application No. 62/539,627, filed on Aug. 1, 2017.
(60) Provisional application No. 62/552,949, filed on Aug. 31, 2017.

(51) Int. Cl. H04W 52/02; H04W 72/12

(52) U.S. Cl. CPC H04W 52/0235; H04W 72/1284; H04W 72/1268

(57) ABSTRACT

Embodiments of a station (STA), an access point (AP) and methods of communication are generally described herein. The STA may receive control signaling that indicates a target wakeup time service period (TWT SP) for contention based access by the STA for transmission of uplink control frames. The TWT SP may be included in a beacon interval. The STA may contend for access during the TWT SP. The STA may transmit an uplink control frame during the TWT SP. The STA may refrain from contention for access outside of the TWT SP during the beacon interval. The STA may attempt to detect trigger frames (TFs) outside of the TWT SP during the beacon interval. If a TF is detected, the STA may determine whether the detected TF indicates a scheduled transmission of an uplink data frame by the STA.

### PRIORITY CLAIM

This application claims priority to U.S. Provisional Patent Application Ser. No. 62/539,627, filed Aug. 1, 2017, and to U.S. Provisional Patent Application Ser. No. 62/552,949, filed Aug. 31, 2017, both of which are incorporated herein by reference in their entirety.

### TECHNICAL FIELD

Embodiments pertain to wireless communications. Some embodiments relate to wireless local area networks (WLANs) and Wi-Fi networks including networks operating in accordance with the IEEE 802.11 family of standards. Some embodiments relate to communication in accordance with IEEE 802.11ax networks and/or IEEE 802.11az networks. Some embodiments relate to target wakeup time (TWT) protocols. Some embodiments relate to contention based access.

### BACKGROUND

In some cases, devices may communicate over a wireless channel to exchange information such as voice, data and/or other. Some devices operating in the wireless channel may support features intended to provide improved performance over legacy operation. Legacy devices may not necessarily support some or all of those features, but may continue to operate in the wireless channel. In some cases, a base station may support newer devices and legacy devices concurrently, which may provide additional challenges. Accordingly, there is a general need for techniques to enable support of devices of different capabilities, such as newer devices, legacy devices and/or other devices, in these and other scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 is a block diagram of a radio architecture in accordance with some embodiments;

FIG. 5 illustrates a front-end module circuitry for use in the radio architecture of FIG. 4 in accordance with some embodiments;

FIG. 6 illustrates a radio IC circuitry for use in the radio architecture of FIG. 4 in accordance with some embodiments;

FIG. 7 illustrates a baseband processing circuitry for use in the radio architecture of FIG. 4 in accordance with some embodiments;

FIG. 8 illustrates the operation of a method of communication in accordance with some embodiments;

FIG. 9 illustrates the operation of another method of communication in accordance with some embodiments; and

FIG. 10 illustrates example elements that may be exchanged in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

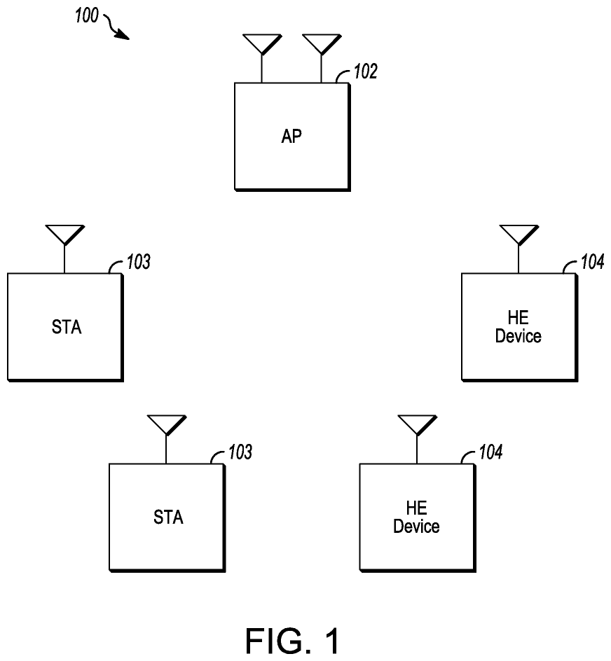

FIG. 1 illustrates a wireless network in accordance with some embodiments. In some embodiments, the network 100 may be a High Efficiency (HE) Wireless Local Area Network (WLAN) network. In some embodiments, the network 100 may be a WLAN or a Wi-Fi network. These embodiments are not limiting, however, as some embodiments of the network 100 may include a combination of such networks. That is, the network 100 may support HE operation in some cases, non-HE operation in some cases, and a combination of HE operation and non-HE operation in some cases. The network 100 may support multi-user (MU) operation in some cases, non-MU operation in some cases, and a combination of MU operation and non-MU operation in some cases.

Referring to FIG. 1, the network 100 may include any or all of the components shown, and embodiments are not limited to the number of each component shown in FIG. 1 and are also not limited to the types of components shown in FIG. 1. Embodiments are also not limited by the example network 100 in terms of the arrangement of the components or the connectivity between components as shown. In addition, some embodiments may include additional components.

In some embodiments, the network 100 may include an AP 102 (which may be a master station in some embodiments) and may include any number (including zero) of stations (STAs) 103 and/or HE devices 104. In some embodiments, the AP 102 may receive and/or detect signals from one or more STAs 103, and may transmit data packets to one or more STAs 103. These embodiments will be described in more detail below. In some embodiments, the AP 102 may receive and/or detect signals from one or more HE devices 104, and may transmit data packets to one or more HE devices 104.

It should be noted that embodiments are not limited to networks that include APs 102, however, as other base station components may be included in some embodiments. Such components may or may not be arranged to operate in accordance with a standard, in some embodiments. As an example, an Evolved Node-B (eNB) arranged to operate in accordance with one or more Third Generation Partnership Project (3GPP) standards, including but not limited to 3GPP Long Term Evolution (LTE) standards, may be used in some cases.

In some embodiments, the STAs 103 may be arranged to operate in accordance with one or more IEEE 802.11 standards, including but not limited to 802.11ax and/or 802.11az. These embodiments are not limiting, however, as other mobile devices, portable devices and/or other devices, which may or may not be arranged to operate in accordance with a standard, may be used in some embodiments. As an example, a User Equipment (UE) arranged to operate in accordance with one or more Third Generation Partnership Project (3GPP) standards, including but not limited to 3GPP LTE standards, may be used in some cases.

The AP 102 may be arranged to communicate with one or more of the components shown in FIG. 1 in accordance with one or more IEEE 802.11 standards (including 802.11ax, 802.11az and/or others), other standards and/or other communication protocols. It should be noted that embodiments are not limited to usage of an AP 102. References herein to the AP 102 are not limiting and references herein to a master station are also not limiting. In some embodiments, an STA 103, an MU operation device (device capable of MU operation), an HE device 104 and/or other device may be configurable to operate as a master station. In some embodiments, operations that may be performed by the AP 102 as described herein may be performed by the STA 103, an MU operation device, an HE device 104, a device that is configurable to operate as an AP 102 and/or a device that is configurable to operate as a master station.

In some embodiments, the STA 103 may be configured to operate as an HE device 104. References herein to an STA 103 or to an HE device 104 are not limiting. Although descriptions herein may refer to performance of one or more techniques, operations and/or methods by an STA 103, it is understood that some or all of those techniques, operations and/or methods may be performed by an HE device 104, in some embodiments. In addition, it is understood that some or all of those techniques, operations and/or methods may be performed by an STA 103 configured to operate as an HE device 104, in some embodiments.

In some embodiments, communication between the AP 102 and the STAs 103 and/or communication between the STAs 103 may be performed in accordance with one or more standards, such as an 802.11 standard (including legacy 802.11 standards), a 3GPP standard (including 3GPP LTE standards) and/or other standards. These embodiments are not limiting, however, as other communication techniques and/or protocols (which may or may not be included in a standard) may be used for the communication between the AP 102 and the STAs 103 and/or the communication between the STAs 103, in some embodiments. Embodiments are not limited to communication as part of a network. In some embodiments, communication between two or more STAs 103 may not necessarily involve a network. In some cases, at least a portion of the communication may include direct communication between the STAs 103.

It should also be noted that the AP 102 may operate as an STA 103, in some embodiments. Some techniques, operations and/or methods may be described herein in terms of communication between two STAs 103, but such descriptions are not limiting. Some or all of those techniques, operations and/or methods may be applicable to scenarios in which an STA 103 and an AP 102 communicate. In addition, some techniques, operations and/or methods may be described herein in terms of communication between an STA 103 and an AP 102, but such descriptions are not limiting. Some or all of those techniques, operations and/or methods may be applicable to scenarios in which two or more STAs 103 communicate.

In some embodiments, one or more of the STAs 103 may be legacy stations (for instance, a non-HE device, a device not capable of HE operation, a non-MU operation device and/or device not capable of MU operation). These embodiments are not limiting, however, as an STA 103 may be configured to operate as an HE device 104 and/or may support HE operation, in some embodiments. In some embodiments, the STA 103 may be configured to operate as an MU device and/or may support MU operation.

The AP 102 may be arranged to communicate with the STAs 103, HE devices 104 and/or MU devices in accordance with one or more of the IEEE 802.11 standards, including 802.11ax, 802.11az and/or others. In accordance with some embodiments (including but not limited to HE operation embodiments), an AP 102 may operate as a master station.

In some embodiments, the AP 102 may be arranged to contend for a wireless medium (e.g., during a contention period) to receive exclusive control of the medium for an 802.11 air access control period (i.e., a transmission opportunity (TXOP)). The AP 102 may, for example, transmit a master-sync or control transmission at the beginning of the 802.11 air access control period (including but not limited to an HE control period) to indicate, among other things, which STAs 103 and/or HE devices 104 are scheduled for communication during the 802.11 air access control period. During the 802.11 air access control period, the scheduled STAs 103 and/or HE devices 104 may communicate with the AP 102 in accordance with a non-contention based multiple access technique. This is unlike conventional Wi-Fi communications in which devices communicate in accordance with a contention-based communication technique, rather than a non-contention based multiple access technique. During the 802.11 air access control period, the AP 102 may communicate with STAs 103 and/or HE devices 104 using one or more MU PPDUs. During the 802.11 air access control period, STAs 103 not operating in accordance with HE operation may refrain from communicating in some cases. In some embodiments, the master-sync transmission may be referred to as a control and schedule transmission.

In some embodiments, the multiple-access technique used during the 802.11 air access control period may be a scheduled orthogonal frequency-division multiple access (OFDMA) technique, although this is not a requirement. In some embodiments, the multiple access technique may be a time-division multiple access (TDMA) technique or a frequency-division multiple access (FDMA) technique. In some embodiments, the multiple access technique may be a space-division multiple access (SDMA) technique including a multi-user (MU) multiple-input multiple-output (MIMO) (MU-MIMO) technique or combination of the above. These multiple-access techniques used during the 802.11 air access control period may be configured for uplink or downlink data communications.

The AP 102 may also communicate with STAs 103 and/or other legacy stations in accordance with legacy IEEE 802.11 communication techniques. In some embodiments, the AP 102 may also be configurable to communicate with the STAs 103 and/or legacy stations outside the 802.11 air access control period in accordance with legacy IEEE 802.11 communication techniques, although this is not a requirement.

In some embodiments, communication (including but not limited to communication during the control period) may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, sub-channel bandwidths less than 20 MHz may also be used. In these embodiments, each channel or sub-channel of a communication may be configured for transmitting a number of spatial streams.

In some embodiments, multi-user (MU) techniques may be used, although the scope of embodiments is not limited in this respect. As an example, MU techniques included in 802.11ax standards, 802.11az standards and/or other standards may be used. In accordance with some embodiments, an AP 102, STA 103 and/or HE device 104 may generate an MU packet in accordance with a short preamble format or a long preamble format. The MU packet may comprise a legacy signal field (L-SIG) followed by one or more MU signal fields (HE-SIG) and an MU long-training field (MU-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

In some embodiments, the STAs 103, AP 102, other mobile devices, other base stations and/or other devices may be configured to perform operations related to contention based communication. As an example, a communication between an STAs 103 and an AP 102 may be performed in accordance with contention based techniques. As another example, a communication between multiple STAs 103 may be performed in accordance with contention based techniques. In these examples and other scenarios, the STAs 103 and/or AP 102 may be arranged to contend for a wireless medium (e.g., during a contention period) to receive exclusive control of the medium for a transmission period. For instance, the transmission period may include a transmission opportunity (TXOP), which may be included in an 802.11 standard and/or other standard.

It should be noted that embodiments are not limited to usage of contention based techniques, however, as some communication (such as that between mobile devices and/or communication between a mobile device and a base station) may be performed in accordance with schedule based techniques. Some embodiments may include a combination of contention based techniques and schedule based techniques.

In some embodiments, communication may be performed in accordance with any suitable multiple-access techniques and/or multiplexing techniques. Such communication may include, but is not limited to, communication between multiple STAs 103 and/or communication between an STA 103 and an AP 102. Accordingly, one or more of orthogonal frequency division multiple access (OFDMA), orthogonal frequency division multiplexing (OFDM), code-division multiple access (CDMA), time-division multiple access (TDMA), frequency division multiplexing (FDMA), space-division multiple access (SDMA), multiple-input multiple-output (MIMO), multi-user (MU) multiple-input multiple-output (MIMO) (MU-MIMO) and/or other techniques may be employed in some embodiments.

In some embodiments, channels used for communication between STAs 103 and/or APs 102 may be 2.16 GHz, 4.32 GHz, 6.48 GHz, 8.72 GHz and/or other suitable value. In some embodiments, channels used for communication between STAs 103 and/or APs 102 may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel may be configured for transmitting a number of spatial streams, in some embodiments. The values given above may be part of an 802.11 standard, in some cases, although embodiments are not limited as such. These embodiments are not limiting, however, as other suitable bandwidths may be used in some embodiments. In addition, embodiments are not limited to channel types or channel sizes that are included in a standard.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

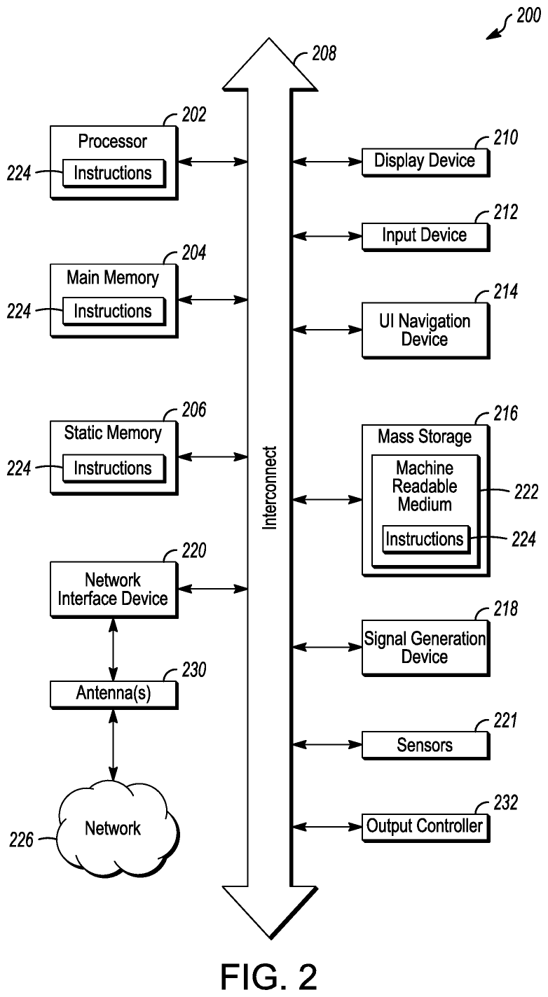

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, HE device 104, User Equipment (UE), Evolved Node-B (eNB), mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine-readable medium may be or may include a non-transitory computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

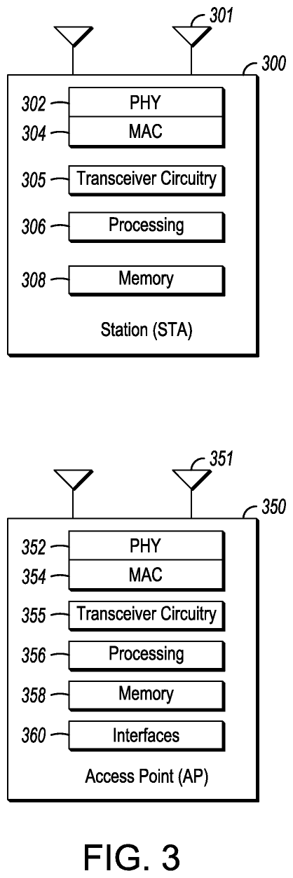

FIG. 3 illustrates a station (STA) in accordance with some embodiments and an access point (AP) in accordance with some embodiments. It should be noted that in some embodiments, an STA, HE device and/or other mobile device may include one or more components shown in FIGS. 2-7. In some embodiments, the STA 300 may be suitable for use as an STA 103 as depicted in FIG. 1, although the scope of embodiments is not limited in this respect. In some embodiments, the STA 300 may be suitable for use as an HE device 104 as depicted in FIG. 1, although the scope of embodiments is not limited in this respect. It should also be noted that in some embodiments, an AP or other base station may include one or more components shown in FIGS. 2-7. In some embodiments, the AP 350 may be suitable for use as an AP 102 as depicted in FIG. 1, although the scope of embodiments is not limited in this respect.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control (MAC) layer circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control (MAC) layer circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 may be configured to communicate using OFDM and/or OFDMA communication signals over a multicarrier communication channel. In some embodiments, the AP 350 may be configured to communicate using OFDM and/or OFDMA communication signals over a multicarrier communication channel. Accordingly, in some cases, the STA 300 and/or AP 350 may be configured to receive signals in accordance with specific communication standards, such as the Institute of Electrical and Electronics Engineers (IEEE) standards including IEEE 802.11-2012, 802.11n-2009, 802.11ac-2013 standards, 802.11ax standards (and/or proposed standards), 802.11ay standards (and/or proposed standards) and/or other, although the scope of the embodiments is not limited in this respect as they may also be suitable to transmit and/or receive communications in accordance with other techniques and standards. In some other embodiments, the AP 350 and/or the STA 300 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

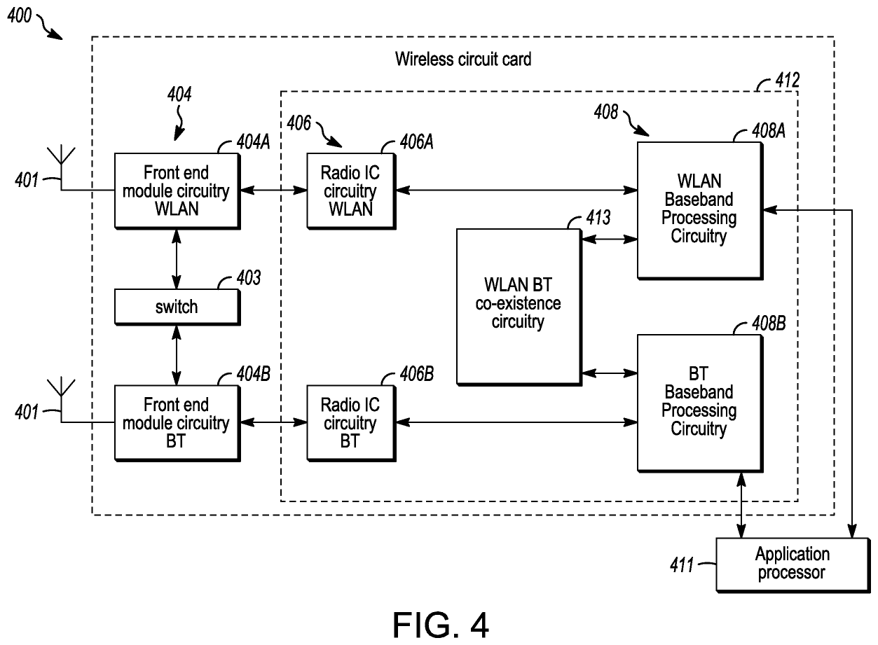

It should be noted that in some embodiments, an apparatus of the STA 300 may include various components of the STA 300 as shown in FIG. 3 and/or the example machine 200 as shown in FIG. 2 and/or various components shown in FIGS. 4-7. Accordingly, techniques and operations described herein that refer to the STA 300 (or 103) may be applicable to an apparatus of an STA, in some embodiments. In addition, techniques and operations described herein that refer to the STA 300 (or 103) may be applicable to an apparatus of an HE device, in some embodiments.

It should also be noted that in some embodiments, an apparatus of the AP 350 may include various components of the AP 350 as shown in FIG. 3 and/or the example machine 200 as shown in FIG. 2 and/or various components shown in FIGS. 4-7. Accordingly, techniques and operations described herein that refer to the AP 350 (or 102) may be applicable to an apparatus of an AP, in some embodiments. In addition, an apparatus of a mobile device and/or base station may include one or more components shown in FIGS. 2-7, in some embodiments. Accordingly, techniques and operations described herein that refer to a mobile device and/or base station may be applicable to an apparatus of a mobile device and/or base station, in some embodiments.

FIG. 4 is a block diagram of a radio architecture 400 in accordance with some embodiments. Radio architecture 400 may include radio front-end module (FEM) circuitry 404, radio IC circuitry 406 and baseband processing circuitry 408. Radio architecture 400 as shown includes both Wireless Local Area Network (WLAN) functionality and Bluetooth (BT) functionality although embodiments are not so limited. In this disclosure, “WLAN” and “Wi-Fi” are used interchangeably.

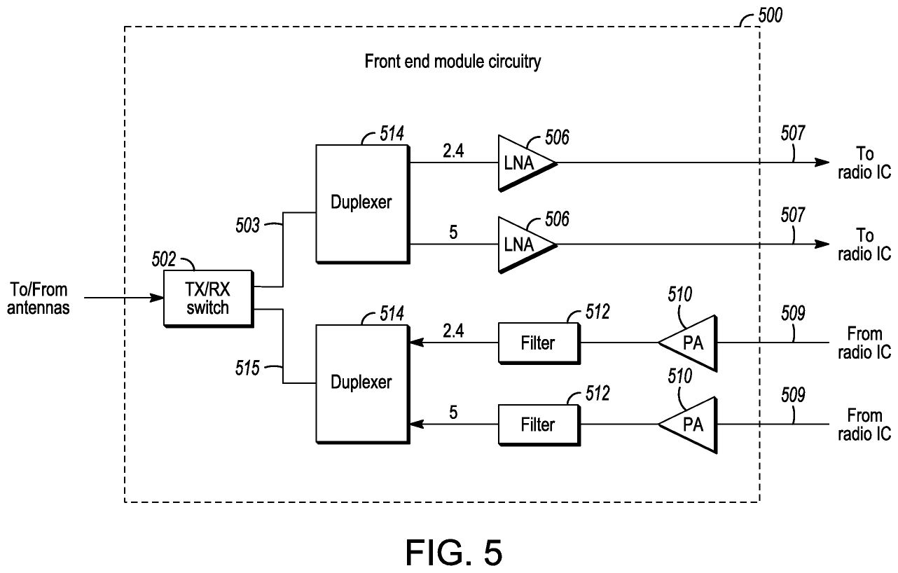

It should be noted that the radio architecture 400 and components shown in FIGS. 5-7 support WLAN and BT, but embodiments are not limited to WLAN or BT. In some embodiments, two technologies supported by the radio architecture 400 may or may not include WLAN or BT. Other technologies may be supported. In some embodiments, WLAN and a second technology may be supported. In some embodiments, BT and a second technology may be supported. In some embodiments, two technologies other than WLAN and BT may be supported. In addition, the radio architecture 400 may be extended to support more than two protocols, technologies and/or standards, in some embodiments. Embodiments are also not limited to the frequencies illustrated in FIGS. 4-7.

FEM circuitry 404 may include a WLAN or Wi-Fi FEM circuitry 404a and a Bluetooth (BT) FEM circuitry 404b. The WLAN FEM circuitry 404a may include a receive signal path comprising circuitry configured to operate on WLAN RF signals received from one or more antennas 401, to amplify the received signals and to provide the amplified versions of the received signals to the WLAN radio IC circuitry 406a for further processing. The BT FEM circuitry 404b may include a receive signal path which may include circuitry configured to operate on BT RF signals received from one or more antennas 402, to amplify the received signals and to provide the amplified versions of the received signals to the BT radio IC circuitry 406b for further processing. FEM circuitry 404a may also include a transmit signal path which may include circuitry configured to amplify WLAN signals provided by the radio IC circuitry 406a for wireless transmission by one or more of the antennas 401. In addition, FEM circuitry 404b may also include a transmit signal path which may include circuitry configured to amplify BT signals provided by the radio IC circuitry 406b for wireless transmission by the one or more antennas. In the embodiment of FIG. 4, although FEM 404a and FEM 404b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 406 as shown may include WLAN radio IC circuitry 406a and BT radio IC circuitry 406b. The WLAN radio IC circuitry 406a may include a receive signal path which may include circuitry to down-convert WLAN RF signals received from the FEM circuitry 404a and provide baseband signals to WLAN baseband processing circuitry 408a. BT radio IC circuitry 406b may in turn include a receive signal path which may include circuitry to down-convert BT RF signals received from the FEM circuitry 404b and provide baseband signals to BT baseband processing circuitry 408b. WLAN radio IC circuitry 406a may also include a transmit signal path which may include circuitry to up-convert WLAN baseband signals provided by the WLAN baseband processing circuitry 408a and provide WLAN RF output signals to the FEM circuitry 404a for subsequent wireless transmission by the one or more antennas 401. BT radio IC circuitry 406b may also include a transmit signal path which may include circuitry to up-convert BT baseband signals provided by the BT baseband processing circuitry 408b and provide BT RF output signals to the FEM circuitry 404b for subsequent wireless transmission by the one or more antennas 401. In the embodiment of FIG. 4, although radio IC circuitries 406a and 406b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 408 may include a WLAN baseband processing circuitry 408a and a BT baseband processing circuitry 408b. The WLAN baseband processing circuitry 408a may include a memory, such as, for example, a set of RAM arrays in a Fast Fourier Transform or Inverse Fast Fourier Transform block (not shown) of the WLAN baseband processing circuitry 408a. Each of the WLAN baseband circuitry 408a and the BT baseband circuitry 408b may further include one or more processors and control logic to process the signals received from the corresponding WLAN or BT receive signal path of the radio IC circuitry 406, and to also generate corresponding WLAN or BT baseband signals for the transmit signal path of the radio IC circuitry 406. Each of the baseband processing circuitries 408a and 408b may further include physical layer (PHY) and medium access control layer (MAC) circuitry, and may further interface with application processor 410 for generation and processing of the baseband signals and for controlling operations of the radio IC circuitry 406.

Referring still to FIG. 4, according to the shown embodiment, WLAN-BT coexistence circuitry 413 may include logic providing an interface between the WLAN baseband circuitry 408a and the BT baseband circuitry 408b to enable use cases requiring WLAN and BT coexistence. In addition, a switch 403 may be provided between the WLAN FEM circuitry 404a and the BT FEM circuitry 404b to allow switching between the WLAN and BT radios according to application needs. In addition, although the antennas 401 are depicted as being respectively connected to the WLAN FEM circuitry 404a and the BT FEM circuitry 404b, embodiments include within their scope the sharing of one or more antennas as between the WLAN and BT FEMs, or the provision of more than one antenna connected to each of FEM 404a or 404b.

In some embodiments, the front-end module circuitry 404, the radio IC circuitry 406, and baseband processing circuitry 408 may be provided on a single radio card, such as wireless radio card 402. In some other embodiments, the one or more antennas 401, the FEM circuitry 404 and the radio IC circuitry 406 may be provided on a single radio card. In some other embodiments, the radio IC circuitry 406 and the baseband processing circuitry 408 may be provided on a single chip or integrated circuit (IC), such as IC 412.

In some embodiments, the wireless radio card 402 may include a WLAN radio card and may be configured for Wi-Fi communications, although the scope of the embodiments is not limited in this respect. In some of these embodiments, the radio architecture 400 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 400 may be part of a Wi-Fi communication station (STA) such as a wireless access point (AP), a base station or a mobile device including a Wi-Fi device. In some of these embodiments, radio architecture 400 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11ac, and/or 802.11ax standards and/or proposed specifications for WLANs, although the scope of embodiments is not limited in this respect. Radio architecture 400 may also be suitable to transmit and/or receive communications in accordance with other techniques and standards.

In some embodiments, the radio architecture 400 may be configured for high-efficiency (HE) Wi-Fi (HEW) communications in accordance with the IEEE 802.11ax standard and/or IEEE 802.11az standard. In these embodiments, the radio architecture 400 may be configured to communicate in accordance with an OFDMA technique, although the scope of the embodiments is not limited in this respect.

In some other embodiments, the radio architecture 400 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 4, the BT baseband circuitry 408b may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 4, the radio architecture 400 may be configured to establish a BT synchronous connection oriented (SCO) link and or a BT low energy (BT LE) link. In some of the embodiments that include functionality, the radio architecture 400 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 4, the functions of a BT radio card and WLAN radio card may be combined on a single wireless radio card, such as single wireless radio card 402, although embodiments are not so limited, and include within their scope discrete WLAN and BT radio cards.

In some embodiments, the radio-architecture 400 may include other radio cards, such as a cellular radio card configured for cellular (e.g., 3GPP such as LTE, LTE-Advanced or 5G communications).

In some IEEE 802.11 embodiments, the radio architecture 400 may be configured for communication over various channel bandwidths including bandwidths having center frequencies of about 900 MHz, 2.4 GHz, 5 GHz. In some embodiments, the bandwidths may be about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. In some embodiments, the bandwidths may be about 2.16 GHz, 4.32 GHz, 6.48 GHz, 8.72 GHz and/or other suitable value. The scope of the embodiments is not limited with respect to the above center frequencies or bandwidths, however.

FIG. 5 illustrates FEM circuitry 500 in accordance with some embodiments. The FEM circuitry 500 is one example of circuitry that may be suitable for use as the WLAN and/or BT FEM circuitry 404a/404b (FIG. 4), although other circuitry configurations may also be suitable.

In some embodiments, the FEM circuitry 500 may include a TX/RX switch 502 to switch between transmit mode and receive mode operation. The FEM circuitry 500 may include a receive signal path and a transmit signal path. The receive signal path of the FEM circuitry 500 may include a low-noise amplifier (LNA) 506 to amplify received RF signals 503 and provide the amplified received RF signals 507 as an output (e.g., to the radio IC circuitry 406 (FIG. 4)). The transmit signal path of the circuitry 500 may include a power amplifier (PA) to amplify input RF signals 509 (e.g., provided by the radio IC circuitry 406), and one or more filters 512, such as band-pass filters (BPFs), low-pass filters (LPFs) or other types of filters, to generate RF signals 515 for subsequent transmission (e.g., by one or more of the antennas 401 (FIG. 4)).

In some dual-mode embodiments for Wi-Fi communication, the FEM circuitry 500 may be configured to operate in either the 2.4 GHz frequency spectrum or the 5 GHz frequency spectrum. In these embodiments, the receive signal path of the FEM circuitry 500 may include a receive signal path duplexer 504 to separate the signals from each spectrum as well as provide a separate LNA 506 for each spectrum as shown. In these embodiments, the transmit signal path of the FEM circuitry 500 may also include a power amplifier 510 and a filter 512, such as a BPF, a LPF or another type of filter for each frequency spectrum and a transmit signal path duplexer 514 to provide the signals of one of the different spectrums onto a single transmit path for subsequent transmission by the one or more of the antennas 401 (FIG. 4). In some embodiments, BT communications may utilize the 2.4 GHZ signal paths and may utilize the same FEM circuitry 500 as the one used for WLAN communications.

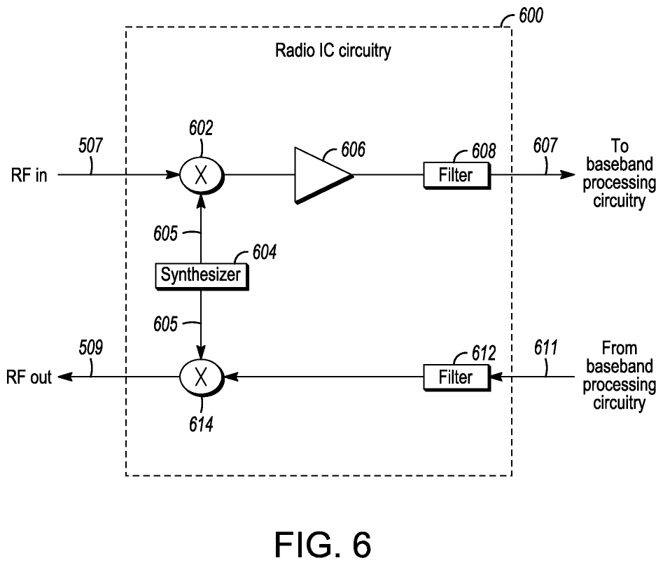

FIG. 6 illustrates radio IC circuitry 600 in accordance with some embodiments. The radio IC circuitry 600 is one example of circuitry that may be suitable for use as the WLAN or BT radio IC circuitry 406a/406b (FIG. 4), although other circuitry configurations may also be suitable.

In some embodiments, the radio IC circuitry 600 may include a receive signal path and a transmit signal path. The receive signal path of the radio IC circuitry 600 may include at least mixer circuitry 602, such as, for example, down-conversion mixer circuitry, amplifier circuitry 606 and filter circuitry 608. The transmit signal path of the radio IC circuitry 600 may include at least filter circuitry 612 and mixer circuitry 614, such as, for example, up-conversion mixer circuitry. Radio IC circuitry 600 may also include synthesizer circuitry 604 for synthesizing a frequency 605 for use by the mixer circuitry 602 and the mixer circuitry 614. The mixer circuitry 602 and/or 614 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 6 illustrates only a simplified version of a radio IC circuitry, and may include, although not shown, embodiments where each of the depicted circuitries may include more than one component. For instance, mixer circuitry 620 and/or 614 may each include one or more mixers, and filter circuitries 608 and/or 612 may each include one or more filters, such as one or more BPFs and/or LPFs according to application needs. For example, when mixer circuitries are of the direct-conversion type, they may each include two or more mixers.

In some embodiments, mixer circuitry 602 may be configured to down-convert RF signals 507 received from the FEM circuitry 404 (FIG. 4) based on the synthesized frequency 605 provided by synthesizer circuitry 604. The amplifier circuitry 606 may be configured to amplify the down-converted signals and the filter circuitry 608 may include a LPF configured to remove unwanted signals from the down-converted signals to generate output baseband signals 607. Output baseband signals 607 may be provided to the baseband processing circuitry 408 (FIG. 4) for further processing. In some embodiments, the output baseband signals 607 may be zero-frequency baseband signals, although this is not a requirement. In some embodiments, mixer circuitry 602 may comprise passive mixers, although the scope of the embodiments is not limited in this respect.

In some embodiments, the mixer circuitry 614 may be configured to up-convert input baseband signals 611 based on the synthesized frequency 605 provided by the synthesizer circuitry 604 to generate RF output signals 509 for the FEM circuitry 404. The baseband signals 611 may be provided by the baseband processing circuitry 408 and may be filtered by filter circuitry 612. The filter circuitry 612 may include a LPF or a BPF, although the scope of the embodiments is not limited in this respect.

In some embodiments, the mixer circuitry 602 and the mixer circuitry 614 may each include two or more mixers and may be arranged for quadrature down-conversion and/or up-conversion respectively with the help of synthesizer 604. In some embodiments, the mixer circuitry 602 and the mixer circuitry 614 may each include two or more mixers each configured for image rejection (e.g., Hartley image rejection). In some embodiments, the mixer circuitry 602 and the mixer circuitry 614 may be arranged for direct down-conversion and/or direct up-conversion, respectively. In some embodiments, the mixer circuitry 602 and the mixer circuitry 614 may be configured for super-heterodyne operation, although this is not a requirement.

Mixer circuitry 602 may comprise, according to one embodiment: quadrature passive mixers (e.g., for the in-phase (I) and quadrature phase (Q) paths). In such an embodiment, RF input signal 507 from FIG. 6 may be down-converted to provide I and Q baseband output signals to be sent to the baseband processor.

Quadrature passive mixers may be driven by zero and ninety degree time-varying LO switching signals provided by a quadrature circuitry which may be configured to receive a LO frequency (f_{LO}) from a local oscillator or a synthesizer, such as LO frequency 605 of synthesizer 604 (FIG. 6). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 507 (FIG. 5) may comprise a balanced signal, although the scope of the embodiments is not limited in this respect. The I and Q baseband output signals may be provided to low-nose amplifier, such as amplifier circuitry 606 (FIG. 6) or to filter circuitry 608 (FIG. 6).

In some embodiments, the output baseband signals 607 and the input baseband signals 611 may be analog baseband signals, although the scope of the embodiments is not limited in this respect. In some alternate embodiments, the output baseband signals 607 and the input baseband signals 611 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 604 may be a fractional-N synthesizer or a fractional N/N+1 synthesizer, although the scope of the embodiments is not limited in this respect as other types of frequency synthesizers may be suitable. For example, synthesizer circuitry 604 may be a delta-sigma synthesizer, a frequency multiplier, or a synthesizer comprising a phase-locked loop with a frequency divider. According to some embodiments, the synthesizer circuitry 604 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 604 may be provided by a voltage controlled oscillator (VCO), although that is not a requirement. A divider control input may further be provided by either the baseband processing circuitry 408 (FIG. 4) or the application processor 410 (FIG. 4) depending on the desired output frequency 605. In some embodiments, a divider control input (e.g., N) may be determined from a look-up table (e.g., within a Wi-Fi card) based on a channel number and a channel center frequency as determined or indicated by the application processor 410.

In some embodiments, synthesizer circuitry 604 may be configured to generate a carrier frequency as the output frequency 605, while in other embodiments, the output frequency 605 may be a fraction of the carrier frequency (e.g., one-half the carrier frequency, one-third the carrier frequency). In some embodiments, the output frequency 605 may be a LO frequency (f_{LO}).

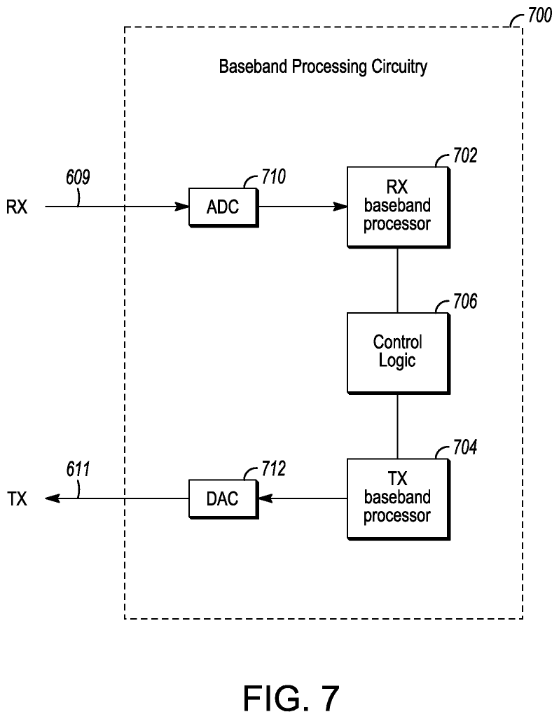

FIG. 7 illustrates a functional block diagram of baseband processing circuitry 700 in accordance with some embodiments. The baseband processing circuitry 700 is one example of circuitry that may be suitable for use as the baseband processing circuitry 408 (FIG. 4), although other circuitry configurations may also be suitable. The baseband processing circuitry 700 may include a receive baseband processor (RX BBP) 702 for processing receive baseband signals 609 provided by the radio IC circuitry 406 (FIG. 4) and a transmit baseband processor (TX BBP) 704 for generating transmit baseband signals 611 for the radio IC circuitry 406. The baseband processing circuitry 700 may also include control logic 706 for coordinating the operations of the baseband processing circuitry 700.

In some embodiments (e.g., when analog baseband signals are exchanged between the baseband processing circuitry 700 and the radio IC circuitry 406), the baseband processing circuitry 700 may include ADC 710 to convert analog baseband signals received from the radio IC circuitry 406 to digital baseband signals for processing by the RX BBP 702. In these embodiments, the baseband processing circuitry 700 may also include DAC 712 to convert digital baseband signals from the TX BBP 704 to analog baseband signals.

In some embodiments that communicate OFDM signals or OFDMA signals, such as through baseband processor 408a, the transmit baseband processor 704 may be configured to generate OFDM or OFDMA signals as appropriate for transmission by performing an inverse fast Fourier transform (IFFT). The receive baseband processor 702 may be configured to process received OFDM signals or OFDMA signals by performing an FFT. In some embodiments, the receive baseband processor 702 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 4, in some embodiments, the antennas 401 (FIG. 4) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 401 may each include a set of phased-array antennas, although embodiments are not so limited.

Although the radio-architecture 400 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

In accordance with some embodiments, the STA 103 may receive control signaling that indicates a target wakeup time service period (TWT SP) for contention based access by the STA 103 for transmission of uplink control frames. The TWT SP may be included in a beacon interval. The STA 103 may contend for access during the TWT SP. The STA 103 may transmit an uplink control frame during the TWT SP. The STA 103 may refrain from contention for access outside of the TWT SP during the beacon interval. The STA 103 may attempt to detect trigger frames (TFs) outside of the TWT SP during the beacon interval. If a TF is detected, the STA 103 may determine whether the detected TF indicates a scheduled transmission of an uplink data frame by the STA 103. These embodiments will be described in more detail below.

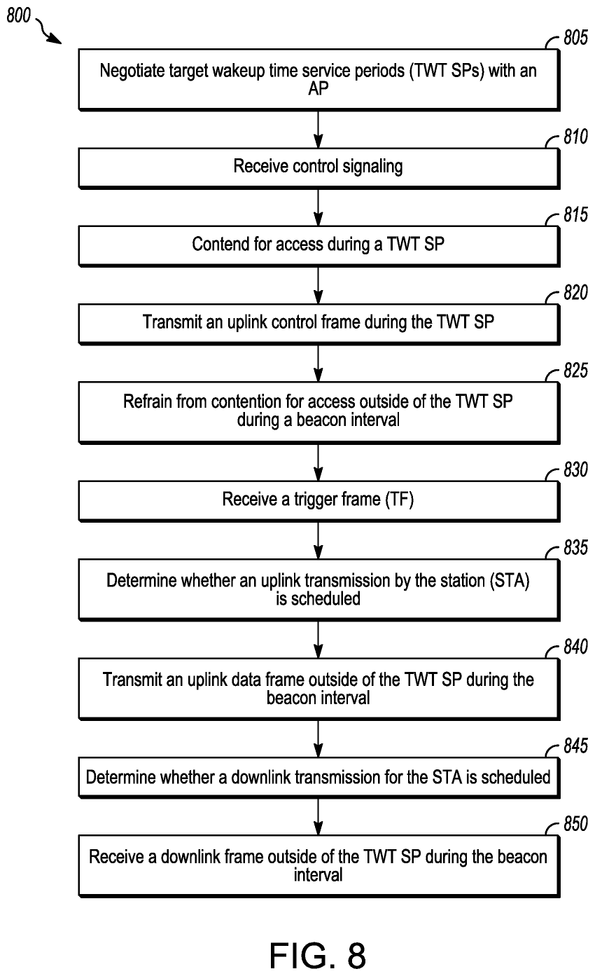

FIG. 8 illustrates the operation of a method of communication in accordance with some embodiments. It is important to note that embodiments of the method 800 may include additional or even fewer operations or processes in comparison to what is illustrated in FIG. 8. In addition, embodiments of the method 800 are not necessarily limited to the chronological order that is shown in FIG. 8. In describing the method 800, reference may be made to FIGS. 1-7 and 9-10, although it is understood that the method 800 may be practiced with any other suitable systems, interfaces and components.

In some embodiments, an STA 103 may perform one or more operations of the method 800, but embodiments are not limited to performance of the method 800 and/or operations of it by the STA 103. In some embodiments, an AP 102 may perform one or more operations of the method 800 (and/or similar operations). Accordingly, although references may be made to performance of one or more operations of the method 800 by the STA 103 in descriptions herein, it is understood that the AP 102 may perform the same operation(s), similar operation(s) and/or reciprocal operation(s), in some embodiments. In some embodiments, an HE device 104 may perform one or more operations of the method 800 (and/or similar operations). Accordingly, although references may be made to performance of one or more operations of the method 800 by the STA 103 in descriptions herein, it is understood that the HE device 104 may perform the same operation(s), similar operation(s) and/or reciprocal operation(s), in some embodiments.

In addition, the method 800 and other methods described herein may refer to STAs 103 or APs 102 operating in accordance with an 802.11 standard, protocol and/or specification and/or WLAN standard, protocol and/or specification, in some cases. Embodiments of those methods are not limited to just those STAs 103 or APs 102 and may also be practiced on other devices, such as a User Equipment (UE), an Evolved Node-B (eNB) and/or other device. In addition, the method 800 and other methods described herein may be practiced by wireless devices configured to operate in other suitable types of wireless communication systems, including systems configured to operate according to various Third Generation Partnership Protocol (3GPP) standards, including but not limited to Long Term Evolution (LTE). The method 800 may also be practiced by an apparatus of an STA 103, an apparatus of an AP 102, an apparatus of an HE device 104 and/or an apparatus of another device, in some embodiments.

It should also be noted that embodiments are not limited by references herein (such as in descriptions of the methods 800, 900 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

Any suitable frequency band(s) may be used for transmission and/or reception as part of the method 800, 900 and/or other methods described herein. In a non-limiting example, a frequency band that includes 6 GHz may be used. In another non-limiting example, a frequency band that is at least partly between 6 GHz and 7 GHz may be used.

In some embodiments, the STA 103 may communicate with the AP 102 while the STA 103 is associated with the AP 102. In some embodiments, the STA 103 may communicate with the AP 102 while the STA 103 is unassociated with the AP 102. In some embodiments, one or more operations described herein (including but not limited to operations of the method 800) may be performed by a STA 103 while the STA 103 is associated with the AP 102. In some embodiments, one or more operations described herein (including but not limited to operations of the method 800) may be performed by a STA 103 while the STA 103 is unassociated with the AP 102.

At operation 805, the STA 103 may negotiate target wakeup time service periods (TWT SPs) with an AP 102. In some embodiments, the TWT SPs may be for transmission of uplink control frames by the STA 103. Embodiments are not limited to transmission of uplink control frames by the STA 103 in the TWT SPs, however, as other types of frames (including uplink data frames) may be transmitted in some embodiments.

In some embodiments, contention based access by the STA 103 during a beacon interval may be restricted to a TWT SP of the beacon interval. Access by the STA 103 outside of the TWT SP during the beacon interval may be restricted to scheduled access indicated by a trigger frame (TF) from an AP 102.

In some embodiments, contention based access by the STA during a TWT SP of a beacon interval may be permissible. Contention based access by the STA 103 outside of the TWT SP during the beacon interval may be restricted and/or forbidden. Scheduled access by the STA 103 outside of the TWT SP during the beacon interval may be permissible. The scheduled access may be based on a TF from an AP 102.

As part of the negotiation, the STA 103 and AP 102 may exchange one or more messages. In some embodiments, the messages may include one or more of: proposed parameter(s), updated parameter(s), final parameter(s), other parameter(s), whether parameter(s) are accepted or rejected and/or other information. The messages may be exchanged in multiple stages, in some cases. For instance, the AP 102 may transmit a first message to the STA 103 that includes a proposed value of a parameter. The STA 103 may respond with a second message that includes an indication of whether the proposed value is accepted, a proposed change to the value and/or other. The AP 102 may transmit a third message that indicates a final value and/or other.

At operation 810, the STA 103 may receive control signaling. In some embodiments, the STA 103 may receive the control signaling from the AP 102, although the scope of embodiments is not limited in this respect. Some or all of the control signaling may be related to the negotiation of operation 805, in some embodiments.

In a non-limiting example, the control signaling may indicate one or more TWT SPs for contention based access by the STA 103. For instance, the TWT SPs may be for contention based access by the STA 103 for transmission of uplink control frames. In some embodiments, the TWT SPs may be for contention based access for transmission of other types of uplink frames and/or other elements.

In some embodiments, the TWT SP(s) may be for a TWT mode in which the contention based access is restricted outside of the TWT SP during the beacon interval. The control signaling may include an indicator of whether the TWT mode is to be enabled or disabled, in some embodiments.

In some embodiments, the control signaling may be received from the AP 102 as part of a negotiation between the AP 102 and the STA 103 for an establishment of a plurality of TWT SPs in a plurality of beacon intervals. The control signaling may indicate a duration of the TWT SPs, a start time of the TWT SPs, a periodicity of the TWT SPs and/or other information.

In some embodiments, the TWT SP(s) may be for a TWT mode in which the contention based access is restricted outside of the TWT SP during the beacon interval. The STA 103 may transmit an element that includes a high efficiency (HE) capability field that indicates whether the TWT mode is supported by the STA 103, in some embodiments.

In some embodiments, the control signaling may be received as part of a unilateral indication, by the AP 102, of a plurality of TWT SPs in a plurality of beacon intervals. The control signaling may indicate a duration of the TWT SPs, a start time of the TWT SPs, a periodicity of the TWT SPs and/or other information.

In some embodiments, the control signaling may indicate one or more of: a restriction for transmission outside of the TWT SP during the beacon interval; and a restriction for transmission inside of the TWT SP during the beacon interval. In a non-limiting example, such information may be included in a TWT flow identifier field. Other elements may be used, in some embodiments.

The control signaling may be included in one or more frames. Any suitable frame(s) may be used for the control signaling. Non-limiting examples include a beacon frame, a TWT response frame, an association response, a probe response and a basic service set (BSS) transition management frame.

At operation 815, the STA 103 may contend for access during a TWT SP. Any suitable contention methods, operations and/or techniques may be used, which may or may not be part of a standard. In a non-limiting example, one or more contention methods, operations and/or techniques of an 802.11 standard/protocol and/or WLAN standard/protocol may be used. In some embodiments, the STA 103 may be arranged to operate in accordance with a wireless local area network (WLAN) protocol, and the contention based access may include access in accordance with an enhanced distributed channel access (EDCA) technique.

At operation 820, the STA 103 may transmit an uplink control frame during the TWT SP. Embodiments are not limited to transmission of uplink control frames during the TWT SP, however. In some embodiments, the STA 103 may transmit other frames, including but not limited to uplink data frames, during the TWT SP. Non-limiting examples of uplink control frames include power save (PS) poll frames, quality of service (QoS) frames and sounding frames.

At operation 825, the STA 103 may refrain from contention for access outside of the TWT SP during the beacon interval.

At operation 830, the STA 103 may receive a trigger frame (TF). In some embodiments, the STA 103 may receive the TF from the AP 102, although the scope of embodiments is not limited in this respect. In some embodiments, the STA 103 may attempt to detect TFs outside of the TWT SP during the beacon interval, although the scope of embodiments is not limited in this respect. In some embodiments, the STA 103 may attempt to detect TFs during a time period that at least partly overlaps a TWT SP.

In some embodiments, the TF may indicate a scheduled uplink transmission by the STA 103. In some embodiments, the TF may indicate a scheduled uplink transmission by the STA 103 outside of the TWT SP during the beacon interval. In some embodiments, the TF may indicate a scheduled uplink transmission by the STA 103 during a period that at least partly overlaps the TWT SP. In some embodiments, the TF may indicate a scheduled downlink transmission for the STA 103. In some embodiments, the TF may indicate a scheduled downlink transmission for the STA 103 outside of the TWT SP during the beacon interval. In some embodiments, the TF may indicate a scheduled downlink transmission for the STA 103 during a period that at least partly overlaps the TWT SP.

In some embodiments, the TF may be transmitted during a transmission opportunity (TXOP). In some embodiments, the TF may be transmitted during a TXOP obtained by the AP 102. In some embodiments, the TF may indicate information to be used by the STA 103 to exchange one or more frames, signals and/or other elements with the AP 102. In some embodiments, the TF may indicate information to be used by the STA 103 to exchange one or more frames, signals and/or other elements with the AP 102 during the TXOP, although the scope of embodiments is not limited in this respect. Example information of the TF may include, but is not limited to, time resources to be used for transmission and/or reception, channel resources (such as resource units (RUs) and/or other) to be used for transmission and/or reception, identifiers of STAs 103 that are to transmit, identifiers of STAs 103 that are to receive and/or other information. It should be noted that embodiments are not limited to usage of the TF, and some embodiments may not necessarily include the usage of the TF.

In a non-limiting example, the TF may indicate a specific allocation of RUs of the channel to be used by one or more associated STAs 103 for transmission of frames, signals and/or other elements. In another non-limiting example, the TF may indicate one or more RUs of the channel to be used by one or more associated STAs 103 for transmission of frames, signals and/or other elements and may further indicate one or more RUs of the channel to be used by one or more unassociated STAs 103 for transmission of frames, signals and/or other elements. In another non-limiting example, the TF may indicate one or more RUs of the channel to be used by one or more unassociated STAs 103 for transmission of frames, signals and/or other elements. In another non-limiting example, the TF may indicate information related to uplink transmission by associated STAs 103, unassociated STAs 103 or a combination thereof. For instance, the TF may be configurable to allocate at least a first RU to a particular associated STA 103 and may be further configurable to allocate at least a second RU for unassociated STAs 103. It should be noted that multiple STAs 103 may be supported. For instance, the TF may allocate one or more RUs to each of multiple STAs 103 for transmissions, in some cases.

At operation 835, the STA 103 may determine, based on the TF, whether an uplink transmission by the STA 103 is scheduled. At operation 840, the STA 103 may transmit an uplink frame (such as an uplink data frame, an uplink control frame and/or other). In some embodiments, the STA 103 may transmit the uplink frame if the TF indicates that the uplink transmission is scheduled, although the scope of embodiments is not limited in this respect. In some embodiments, the STA 103 may transmit the uplink frame in accordance with schedule information and/or other information included in the TF.

In some embodiments, the STA 103 may transmit the uplink frame outside of the TWT SP during the beacon interval, although the scope of embodiments is not limited in this respect. In some embodiments, the STA 103 may transmit the uplink frame during the beacon interval in a period that at least partly overlaps the TWT SP. In some embodiments, the STA 103 may transmit the uplink frame during a TXOP (including but not limited to a TXOP obtained by the AP 102), although the scope of embodiments is not limited in this respect. In some embodiments, the uplink frame may be multiplexed in accordance with an OFDMA technique, although the scope of embodiments is not limited in this respect.

In some embodiments, the uplink frame may be a trigger based physical layer convergence procedure protocol data unit (TB PPDU). In some embodiments, the STA 103 may be restricted to transmission of TB PPDUs during the beacon interval, although the scope of embodiments is not limited in this respect. Embodiments are not limited to transmission of TB PPDUs, as the STA 103 may transmit other PPDUs and/or other elements, in some embodiments.

At operation 845, the STA 103 may determine, based on the TF, whether a downlink transmission for the STA 103 is scheduled. At operation 850, the STA 103 may receive a downlink frame (such as a downlink data frame, a downlink control frame and/or other). In some embodiments, the STA 103 may receive the downlink frame if the TF indicates that the downlink transmission is scheduled, although the scope of embodiments is not limited in this respect. In some embodiments, the STA 103 may receive the downlink frame in accordance with schedule information and/or other information included in the TF.

In some embodiments, the STA 103 may receive the downlink frame outside of the TWT SP during the beacon interval, although the scope of embodiments is not limited in this respect. In some embodiments, the STA 103 may receive the downlink frame during the beacon interval in a period that at least partly overlaps the TWT SP. In some embodiments, the STA 103 may receive the downlink frame during a TXOP, although the scope of embodiments is not limited in this respect. In some embodiments, the downlink frame may be multiplexed in accordance with an OFDMA technique, although the scope of embodiments is not limited in this respect.

In some embodiments, an apparatus of an STA 103 may comprise memory. The memory may be configured to store the TWT SP. The memory may be configured to store one or more other elements and the apparatus may use them for performance of one or more operations. The apparatus may include processing circuitry, which may perform one or more operations (including but not limited to operation(s) of the method 800 and/or other methods described herein). The processing circuitry may include a baseband processor. The baseband circuitry and/or the processing circuitry may perform one or more operations described herein, including but not limited to decoding of the control signaling. The apparatus of the STA 102 may include a transceiver. In some embodiments, the transceiver may receive one or more elements (such as the control signaling and/or other). In some embodiments, the transceiver may transmit one or more elements (such as the uplink control frame and/or other). The transceiver may transmit and/or receive other frames, messages and/or other elements, in some embodiments.

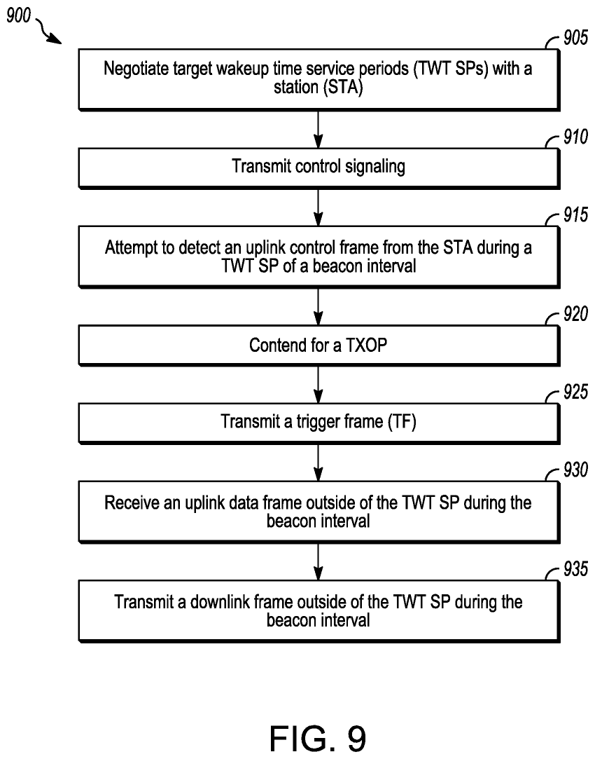

FIG. 9 illustrates the operation of another method of communication in accordance with some embodiments. Embodiments of the method 900 may include additional or even fewer operations or processes in comparison to what is illustrated in FIG. 9 and embodiments of the method 900 are not necessarily limited to the chronological order that is shown in FIG. 9. In describing the method 900, reference may be made to any of FIGS. 1-10, although it is understood that the method 900 may be practiced with any other suitable systems, interfaces and components. In addition, embodiments of the method 900 may be applicable to APs 102, STAs 103, HE devices 104, UEs, eNBs and/or other wireless or mobile devices. The method 900 may also be applicable to an apparatus of an AP 102, STA 103, HE device 104 and/or other device, in some embodiments.

In some embodiments, an AP 102 may perform one or more operations of the method 900, but embodiments are not limited to performance of the method 900 and/or operations of it by the AP 102. In some embodiments, the STA 103 may perform one or more operations of the method 900 (and/or similar operations). Accordingly, although references may be made to performance of one or more operations of the method 900 by the AP 102 in descriptions herein, it is understood that the STA 103 may perform the same operation(s), similar operation(s) and/or reciprocal operation(s), in some embodiments. In some embodiments, an HE device 104 may perform one or more operations of the method 900 (and/or similar operations). Accordingly, although references may be made to performance of one or more operations of the method 900 by the AP 102 in descriptions herein, it is understood that the HE device 104 may perform the same operation(s), similar operation(s) and/or reciprocal operation(s), in some embodiments.

It should be noted that the method 800 may be practiced by an STA 103 and may include exchanging of elements, such as frames, signals, messages and/or other elements with an AP 102. The method 900 may be practiced by an AP 102 and may include exchanging of elements, such as frames, signals, messages and/or other elements with an STA 103. In some cases, operations and techniques described as part of the method 800 may be relevant to the method 900. In some cases, operations and techniques described as part of the method 900 may be relevant to the method 800. In addition, embodiments of the method 900 may include one or more operations that may be the same as, similar to or reciprocal to one or more operations of the method 800 (and/or other operation(s) described herein). For instance, an operation of the method 800 may include reception of an element (such as a frame, block, message and/or other) by an STA 103 and the method 900 may include transmission of a same or similar element by the AP 102. In addition, one or more operations included in the method 800 may be the same as, or similar to, one of more operations included in the method 900.

In addition, previous discussion of various techniques, operations and/or concepts may be applicable to the method 900, in some cases, including TWT, TWT SP, control signaling, negotiation of TWT SP(s), trigger frames (TFs), uplink control frames, uplink data frames, contention based access, scheduled access, TXOP, OFDMA transmission, OFDMA reception and/or others.

At operation 905, the AP 102 may negotiate TWT SPs with an STA 103. At operation 910, the AP 102 may transmit control signaling. In some embodiments, the control signaling may be the same as or similar to the control signaling described as part of the method 800, although the scope of embodiments is not limited in this respect.

At operation 915, the AP 102 may attempt to detect an uplink control frame from the STA 103 during a TWT SP of a beacon interval. At operation 920, the AP 102 may contend for a transmission opportunity (TXOP) to obtain access to a channel. At operation 925, the AP 102 may transmit a TF. At operation 930, the AP 102 may receive an uplink data frame outside of the TWT SP during the beacon interval. At operation 935, the AP 102 may transmit a downlink frame outside of the TWT SP during the beacon interval.

In some embodiments, the AP 102 may communicate with an STA 103 that is associated with the AP 102. In some embodiments, the AP 102 may communicate with an STA 103 that is unassociated with the AP 102. In some embodiments, one or more operations described herein (including but not limited to operations of the method 900) may be performed by the AP 102 while the STA 103 is associated with the AP 102. In some embodiments, one or more operations described herein (including but not limited to operations of the method 900) may be performed by the AP 102 while the STA 103 is unassociated with the AP 102.

In some embodiments, the AP 102 may transmit control signaling to indicate that contention based access by an STA 103 in a beacon interval is restricted to a TWT SP. The AP 102 may schedule an uplink transmission by the STA 103 outside of the TWT SP during the beacon interval. The AP 102 may transmit a TF that indicates the scheduled uplink transmission by the STA 103 during the beacon interval. The AP 102 may receive the uplink transmission from the STA 103. In some embodiments, the control signaling may be transmitted as part of a negotiation between the AP 102 and the STA 103 for an establishment of a plurality of TWT SPs in a plurality of beacon intervals. The control signaling may indicate a duration of the TWT SPs, a start time of the TWT SPs, a periodicity of the TWT SPs and/or other information. In a non-limiting example, the control signaling may be included in a broadcast frame.

In some embodiments, the AP 102 may transmit control signaling that indicates a TWT SP for contention based access for transmission of uplink control frames by an STA 103. Embodiments are not limited to transmission of uplink control frames by the STA 103 in the TWT SP, however. The STA 103 may transmit, in the TWT SP, an uplink data frame and/or other frame in accordance with the contention based access, in some embodiments. The TWT SP may be included in a beacon interval. The AP 102 may attempt to detect an uplink control frame from the STA 103 during the TWT SP. The AP 102 may transmit, outside of the TWT SP during the beacon interval, a TF that indicates a scheduled transmission of an uplink data frame by the STA 103. The AP 102 may receive the uplink data frame from the STA 103. Non-limiting examples of the uplink control frame include a power save (PS) poll frame, a quality of service (QoS) frame, and a sounding frame. In a non-limiting example, the uplink data frame may include a TB PPDU.

In some embodiments, the AP 102 may contend for a TXOP during which the AP 102 is to control access to the channel. In some embodiments, the AP 102 may contend for a wireless medium during a contention period to receive exclusive control of the medium during a period, including but not limited to a TXOP and/or HE control period. The AP 102 may transmit, receive and/or schedule one or more frames and/or signals during the period. The AP 102 may transmit and/or receive one or more frames, signals and/or other elements during the period. However, it should be noted that embodiments are not limited to scheduled transmission and/or reception. Embodiments are also not limited to transmission and/or reception in accordance with the exclusive control of the medium. A frame, signal and/or other element may be transmitted/received in contention-based scenarios and/or other scenarios, in some embodiments. Any suitable contention methods, operations and/or techniques may be used, which may or may not be part of a standard. In a non-limiting example, one or more contention methods, operations and/or techniques of an 802.11 standard/protocol and/or W-LAN standard/protocol may be used.

In some embodiments, an apparatus of an AP 102 may comprise memory. The memory may be configured to store the TWT SP. The memory may be configured to store one or more other elements and the apparatus may use them for performance of one or more operations. The apparatus may include processing circuitry, which may perform one or more operations (including but not limited to operation(s) of the method 900 and/or other methods described herein). The processing circuitry may include a baseband processor. The baseband circuitry and/or the processing circuitry may perform one or more operations described herein, including but not limited to encoding of the control signaling. The apparatus of the AP 102 may include a transceiver. In some embodiments, the transceiver may transmit one or more elements (such as the control signaling and/or other). The transceiver may transmit and/or receive other frames, messages and/or other elements, in some embodiments.

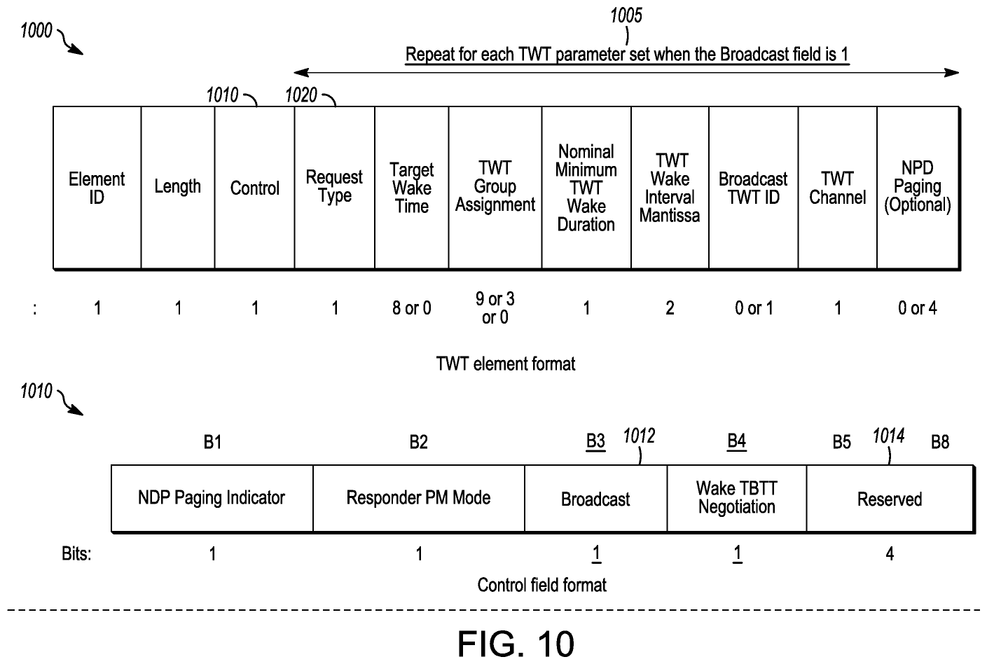

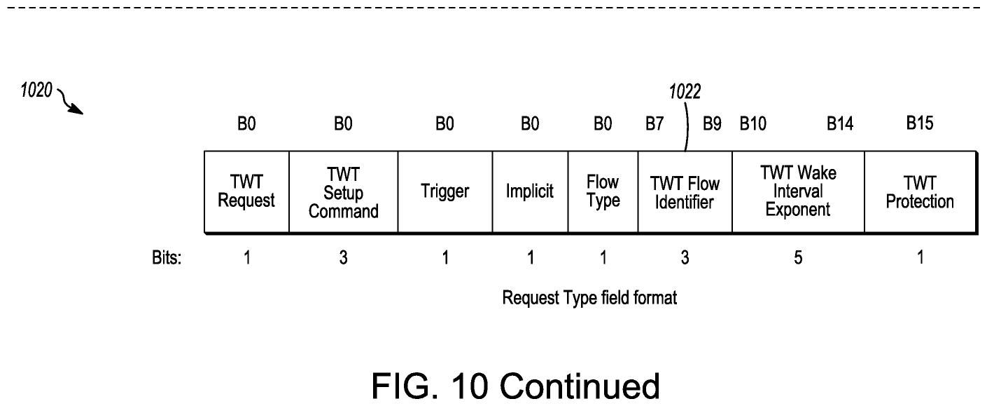

FIG. 10 illustrates example elements that may be exchanged in accordance with some embodiments. It should be noted that the examples shown in FIG. 10 may illustrate some or all of the concepts and techniques described herein in some cases, but embodiments are not limited by the examples of FIG. 10. For instance, embodiments are not limited by the name, number, type, size, ordering, arrangement and/or other aspects of the frames, signals, fields, data blocks, operations, time resources and other elements as shown in FIG. 10. Although some of the elements shown in the examples of FIG. 10 may be included in a standard, such as 802.11, 802.11ax, 802.11az, WLAN and/or other, embodiments are not limited to usage of such elements that are included in standards.

In some embodiments, unlicensed operation may be performed in a frequency band between 6 GHz and 7 GHz. Embodiments are not limited to this frequency range, however. Some or all of the techniques, operations and/or methods described herein may be applicable to other frequency bands, in some embodiments. In some embodiments, a wireless local area network (WLAN) protocol, Wi-Fi protocol, 802.11ax protocol, 802.11 protocol and/or other protocol may be used in that frequency band and/or other frequency bands.

In some embodiments, a channelization for 802.11ax in the frequency band between 6 GHz and 7 GHz may be defined. In a non-limiting example, a standard and/or protocol be used to provide a relatively short time to market, to have products on the market relatively soon and/or to demonstrate (to regulators and/or other parties) that the protocol and/or devices may be ready in a relatively short time frame. In some embodiments, a design consideration may include a restriction that the hardware not be changed in comparison to hardware used for an 802.11ax device in lower frequency bands, and that changes are to be software/management changes.

In some embodiments, a new greenfield (or almost greenfield) Wi-Fi standard may be implemented in the band between 6 GHz and 7 GHz. For instance, the greenfield may be defined as part of a NBT standardization effort, in some cases, although the scope of embodiments is not limited in this respect. In some cases, there may be strong benefits in removing the legacy devices and behaviors and starting a new design with an improved PHY to adapt to the requirements of that band (incumbents that need protection) and with improved MAC to improve scheduling, spatial reuse, predictability and/or other factor(s).

In some embodiments, some software/management features may be defined. Those features may be used, in some cases, to enable one or more operations described herein (such as the restriction related to hardware described above, the definition of the greenfield and/or other(s)). Those features may be used, in some cases, to preserve potential benefits of a new band for NBT greenfield operation.

In some embodiments, features may be designed with goals that may include, but are not limited to, ensuring that the presence of those device will not impact benefits/gains of NBT greenfield. For instance, for better control of the airtime, a protocol may try to ensure that 802.11ax devices are not impacting the efficiency. Accordingly, methods may be used in which the AP 102 may shut down the STAs 103 that use 802.11ax or may at least control/restrict EDCA channel access by those STAs 103.

In some embodiments, NBT may operate with a bandwidth that is larger than bandwidths of 802.11ax systems, legacy systems and/or other systems. It may be undesirable, in some cases, for a system to support a mixture of STAs 103 that operate with very different maximum bandwidths. Efficiency of such a system may be reduced significantly, in some cases.

In some embodiments, devices may support dual band operation and/or multi-band operation. In a non-limiting example, one or more of the following may be used: restriction of direct association at 6 GHz, association at 2.4/5 GHz, mobility at 6 GHz only with BTM requests (MBO or enhanced MBO, OCE and/or other) by the AP 102 and/or other technique(s). One or more of the above may serve as a sort of admission control in the band, in some cases. One or more of the above may be performed in an attempt to ensure backward compatibility in lower bands, in some cases.

In some embodiments, EDCA access for STAs 103 at 6 GHz may be forbidden, and UL MU operation may be permitted, with full AP 102 control on channel access and scheduling. However, such schedule-only 802.11ax operation may likely suffer from inefficiencies, in some cases, such as in early deployments. Example issues may include an increased latency when the AP 102 is not aware of buffers of the STAs 103, UL MU may not necessarily perform better than SU due to overhead and grouping constraints of STAs 103, instabilities during early deployments and/or other issues. Accordingly, a more moderate solution may be desirable, in some cases.

In some embodiments, a mode of TWT (target wake time) may be used. After negotiation with the AP 102 to setup periodic TWT service periods (SPs) (or via a unilateral choice from the AP 102), the STA 103 may operate in accordance with one or more of the following rules, guidelines and/or procedures. The STA 103 may refrain from performance of EDCA to access the medium outside of the TWT SP, in some cases. The TWT SPs may be identified by a field in the TWT element (using one reserved bit). For instance, the field may be referred to as “EDCA” or similar. In a non-limiting example, the bit may be set to 0 for regular TWT SP, and may be set to 1 to indicate that the TWT SP is followed by the STA 103 by applying a rule/guideline/procedure that EDCA may not be performed outside of the TWT.

In some embodiments, one or more rules, guidelines and/or procedures (including but not limited to those described herein) may be included in a standard. In some embodiments, a rule, guideline and/or procedure may be considered “mandatory” for operation in accordance with the standard, although the scope of embodiments is not limited in this respect.

In some embodiments, a TWT element that describes such a mode may be included in one or more of: an unsolicited response TWT frame, which may be transmitted by the AP 102 as part of a unilateral TWT setup by the AP 102); an association response; a probe response; a BSS transition management frame in another band or channel by another AP 102; and/or other frame/message. In such cases, the STA 103 may follow rules, guidelines and/or other procedures of TWT operation without negotiation. In some cases, it may be considered mandatory for operation in accordance with a standard that the STA 103 follow the rules, guidelines and/or other procedures of the TWT operation without negotiation. In a non-limiting example, if included in a BSS transition management frame, restrictions and/or TWT schedule may be respected by an unassociated STA 103 when the unassociated STA 103 begins to monitor and/or communicate in the channel of an AP 102 indicated in a neighbor report.

In some embodiments, a capability bit in an HE capability element for supporting this TWT mode may be used. In a non-limiting example, the STA 103 may set the capability bit to a value (such as 1) to indicate that the STA 103 supports that mode, and may set the capability bit to a value (such as 0) to indicate that the STA 103 does not support that mode. Embodiments are not limited to the mapping between values of the bit and corresponding indications given in the above example.

In some embodiments, a mode of operation (including but not limited to modes described herein) may be optional for the STA 103 in one or more bands (including but not limited to 2.4 GHz band and a 5 GHz band) and may not necessarily be optional for the STA 103 in one or more other bands (including but not limited to a 6 GHz band). In some embodiments, a mode of operation (including but not limited to modes described herein) may be optional for the STA 103 in one or more bands (including but not limited to 2.4 GHz band and a 5 GHz band) and may be considered mandatory (for operation in accordance with a standard) for the STA 103 in one or more other bands (including but not limited to a 6 GHz band). In a non-limiting example, the TWT mode described above may be optional for operation in the 2.4 GHz and 5 GHz bands, and may be considered mandatory (for operation in accordance with an 802.11ax standard and/or other standard) for operation in the 6 GHz band. In some embodiments, if the TWT mode is considered mandatory, it may also be considered mandatory (for operation in accordance with the 802.11ax standard and/or other standard) for the AP 102 to propose sufficient TWT SP for the STA 103 per beacon interval. The proposed TWT SP(s) from the AP 102 may depend on requests from the STA 103 during an association process, in some embodiments. Accordingly, the AP 102 may be prevented from not assigning any TWT SP to the STA 103, in some cases.

In some embodiments, one or more EDCA TWT SPs may indicate when the STA 103 is permitted to use EDCA to access the channel and when the STA 103 may not use EDCA to access the channel. In some embodiments, one or more EDCA TWT SPs may indicate when the STA 103 is permitted to use EDCA to access the channel and when the STA 103 is forbidden from usage of EDCA to access the channel. In some cases, one or more other TWT SPs may overlap with the EDCA TWT SPs and for those TWT SPs, STA power save rules may apply, while the STA power save rules may not necessarily apply to the EDCA TWT SPs. For instance, the AP 102 may consider the STA 103 in a sleep mode outside of TWT SP if the STA is a power save STA 103, while the AP 102 does not consider the STA 103 as being in doze state outside of the EDCA TWT SP. In some cases, the power save rules may also be applicable to the EDCA TWT SPs (such as for other TWT SPs). For instance, the AP 102 may consider the STA 103 to be in a doze state outside of a TWT SP if the STA 103 is a power save STA 103.

In some embodiments, TWT may be used to control frames that may be sent with EDCA inside of the EDCA TWT SP. For instance, one or more elements may be included in a TWT flow identifier for this purpose. In a non-limiting example, the STA 103 may be restricted to use EDCA for one or more packet types, such as resource requests, PS-polls and/or other.

Referring to FIG. 10, an example TWT element 1000 is shown. Some embodiments may not necessarily include all the parameters shown in FIG. 10. Some embodiments may include one or more additional parameters not shown in FIG. 10. Embodiments are not limited to the sizes, numbers of bits, names, ordering and/or other aspects of the parameters shown in FIG. 10.

In some embodiments, the TWT element 1000 may include a control field 1010, although the scope of embodiments is not limited in this respect. An example control field 1010 is also shown in FIG. 10. The example control field 1010 includes a broadcast field 1012 and one or more reserved bits 1014. In some embodiments, one of the reserved bits 1014 may be used to indicate whether a mode of operation (such as a mode in which EDCA is restricted during a TWT SP) is enabled. For instance, a value (such as 1 or other) in one of the reserved bits 1014 may indicate that the mode is enables.

In some embodiments, the TWT element 1000 may include a request type field 1020. In some embodiments, one or more fields (such as the request type field 1020 and/or other field(s)) may be repeated for each TWT parameter set when the broadcast field 1012 is set to a value (such as 1 or other.

In some embodiments, the TWT flow identifier 1022 may be used to define one or more rules outside of the TWT SP and one or more rules inside the TWT SP. Example rules are presented below. The rules may use the word “shall,” which may indicate rules that are mandatory for operation in accordance with a standard, in some cases. The scope of embodiments is not limited in this respect, however. In some embodiments, similar rules may be formulated with the word “may” substituted for the word “shall.” In some embodiments, similar rules may not necessarily be mandatory. In some embodiments, similar rules may not necessarily be mandatory for operation in accordance with a standard.

In a non-limiting example, an example rule applicable outside of the TWT SP may be: the STA 103 shall not send PPDUs, except with TB PPDU format, outside of the TWT SP. This may be used as an alternative to the technique described above for usage of a reserved bit 1014, although the scope of embodiments is not limited in this respect.

In some embodiments, an example rule applicable inside of the TWT SP may be as follows. Frames transmitted during the TWT SP using EDCA shall be limited to: frames with reduced payload sizes that deliver control feedback and/or frames that are sent as part of a sounding feedback exchange (such as for an HE sounding protocol) and/or management frames. Examples of frames with reduced payload sizes that deliver control feedback include, but are not limited to: PS-Poll frames, QoS Null frames, frames in which feedback may be included in a QoS Control field; frame in which feedback may be included in an HE variant HT Control field of the frame, whichever is present (such as HE DL MU operation, UL MU operation, Operating mode indication, Link adaptation using the HLA Control field and/or other).

In Example 1, an apparatus of a station (STA) may comprise memory. The apparatus may further comprise processing circuitry. The processing circuitry may be configured to decode control signaling that indicates a target wakeup time service period (TWT SP) for contention based access by the STA for transmission of uplink control frames. The TWT SP may be included in a beacon interval. The processing circuitry may be further configured to contend for access during the TWT SP. The processing circuitry may be further configured to encode an uplink control frame for transmission during the TWT SP. The processing circuitry may be further configured to refrain from contention for access outside of the TWT SP during the beacon interval. The processing circuitry may be further configured to attempt to detect trigger frames (TFs) outside of the TWT SP during the beacon interval. The processing circuitry may be further configured to, if a TF outside of the TWT SP during the beacon interval is detected: determine whether the detected TF indicates that the STA is scheduled for transmission of an uplink data frame. The memory may be configured to store the TWT SP.

In Example 2, the subject matter of Example 1, wherein the uplink control frame may be a power save (PS) poll frame, a quality of service (QoS) frame or a sounding frame.

In Example 3, the subject matter of one or any combination of Examples 1-2, wherein if the detected TF indicates that the transmission of the uplink data frame by the STA is scheduled, the processing circuitry is configured to encode the uplink data frame in accordance with schedule information included in the detected TF.

In Example 4, the subject matter of one or any combination of Examples 1-3, wherein the uplink data frame may include a trigger based physical layer convergence procedure protocol data unit (TB PPDU).

In Example 5, the subject matter of one or any combination of Examples 1-4, wherein the control signaling may be received from an access point (AP) as part of a negotiation between the AP and the STA for an establishment of a plurality of TWT SPs in a plurality of beacon intervals. The control signaling may indicate a duration of the TWT SPs, a start time of the TWT SPs or a periodicity of the TWT SPs.

In Example 6, the subject matter of one or any combination of Examples 1-5, wherein the TWT SP may be for a TWT mode in which the contention based access is restricted outside of the TWT SP during the beacon interval. The processing circuitry may be further configured to encode, for transmission, a high efficiency (HE) capability field that indicates whether the TWT mode is supported by the STA.

In Example 7, the subject matter of one or any combination of Examples 1-6, wherein the control signaling may be received as part of a unilateral indication, by an access point (AP), of a plurality of TWT SPs in a plurality of beacon intervals. The control signaling may indicate a duration of the TWT SPs, a start time of the TWT SPs or a periodicity of the TWT SPs.

In Example 8, the subject matter of one or any combination of Examples 1-7, wherein the control signaling may be included in a beacon frame.

In Example 9, the subject matter of one or any combination of Examples 1-8, wherein the TWT SP may be for a TWT mode in which the contention based access is restricted outside of the TWT SP during the beacon interval. The control signaling may include an indicator of whether the TWT mode is to be enabled or disabled.

In Example 10, the subject matter of one or any combination of Examples 1-9, wherein the control signaling may be included in a TWT response frame, an association response, a probe response or in a basic service set (BSS) transition management frame.

In Example 11, the subject matter of one or any combination of Examples 1-10, wherein the control signaling may include a TWT flow identifier field that indicates: a restriction for transmission outside of the TWT SP during the beacon interval, or a restriction for transmission inside of the TWT SP during the beacon interval.

In Example 12, the subject matter of one or any combination of Examples 1-11, wherein at least a portion of the control signaling may be received from an access point (AP) while the STA is unassociated with the AP.

In Example 13, the subject matter of one or any combination of Examples 1-12, wherein the STA may be arranged to operate in accordance with a wireless local area network (WLAN) protocol. The contention based access may include access in accordance with an enhanced distributed channel access (EDCA) technique.

In Example 14, the subject matter of one or any combination of Examples 1-13, wherein the apparatus may further include a transceiver to receive the control signaling and to transmit the uplink data frame.

In Example 15, the subject matter of one or any combination of Examples 1-14, wherein the transceiver may be configurable to receive the control signaling and to transmit the uplink data frame in a frequency band that includes 6 GHz.

In Example 16, the subject matter of one or any combination of Examples 1-15, wherein the processing circuitry may include a baseband processor to decode the control signaling.

In Example 17, a computer-readable storage medium may store instructions for execution by one or more processors to perform operations for communication by an access point (AP). The operations may configure the one or more processors to encode, for transmission, control signaling to indicate that contention based access by a station (STA) in a beacon interval is restricted to a target wakeup time service period (TWT SP). The operations may further configure the one or more processors to schedule an uplink transmission by the STA outside of the TWT SP during the beacon interval. The operations may further configure the one or more processors to encode, for transmission, a trigger frame (TF) that indicates the scheduled uplink transmission by the STA during the beacon interval. The operations may further configure the one or more processors to decode the uplink transmission from the STA.

In Example 18, the subject matter of Example 17, wherein the control signaling may be encoded for transmission as part of a negotiation between the AP and the STA for an establishment of a plurality of TWT SPs in a plurality of beacon intervals. The control signaling may indicate a duration of the TWT SPs, a start time of the TWT SPs or a periodicity of the TWT SPs.

In Example 19, the subject matter of one or any combination of Examples 17-18, wherein the control signaling may be encoded for transmission in a broadcast frame.

In Example 20, a method of communication at a station (STA) may comprise decoding control signaling that indicates a target wakeup time service period (TWT SP) of a beacon interval, wherein: contention based access by the STA during the beacon interval is restricted to the TWT SP, access by the STA outside of the TWT SP during the beacon interval is restricted to scheduled access indicated by a trigger frame (TF) from an access point (AP). The method may further comprise contending for access during the TWT SP. The method may further comprise refraining from contention for access outside of the TWT SP during the beacon interval.

In Example 21, the subject matter of Example 20, wherein the method may further comprise detecting a TF outside of the TWT SP during the beacon interval. The method may further comprise determining, based on the detected TF, if an uplink transmission is scheduled for the STA outside of the TWT SP during the beacon interval. The method may further comprise, if it is determined that the uplink transmission is scheduled for the STA: encoding a frame for the uplink transmission.

In Example 22, an apparatus of an access point (AP) may comprise memory. The apparatus may further comprise processing circuitry. The processing circuitry may be configured to encode, for transmission, control signaling that indicates a target wakeup time service period (TWT SP) for contention based access for transmission of uplink control frames by a station (STA). The TWT SP may be included in a beacon interval. The processing circuitry may be further configured to attempt to detect an uplink control frame from the STA during the TWT SP. The processing circuitry may be further configured to encode, for transmission outside of the TWT SP during the beacon interval, a trigger frame (TF) that indicates a scheduled transmission of an uplink data frame by the STA. The processing circuitry may be further configured to decode the uplink data frame from the STA. The memory may be configured to store the TWT SP.

In Example 23, the subject matter of Example 22, wherein: the uplink control frame is a power save (PS) poll frame, a quality of service (QoS) frame or a sounding frame, or the uplink data frame includes a trigger based physical layer convergence procedure protocol data unit (TB PPDU).

In Example 24, an apparatus of an access point (AP) may comprise means for encoding, for transmission, control signaling to indicate that contention based access by a station (STA) in a beacon interval is restricted to a target wakeup time service period (TWT SP). The apparatus may further comprise means for scheduling an uplink transmission by the STA outside of the TWT SP during the beacon interval. The apparatus may further comprise means for encoding, for transmission, a trigger frame (TF) that indicates the scheduled uplink transmission by the STA during the beacon interval. The apparatus may further comprise means for decoding the uplink transmission from the STA.

In Example 25, the subject matter of Example 24, wherein the control signaling may be encoded for transmission as part of a negotiation between the AP and the STA for an establishment of a plurality of TWT SPs in a plurality of beacon intervals. The control signaling may indicate a duration of the TWT SPs, a start time of the TWT SPs or a periodicity of the TWT SPs.

In Example 26, the subject matter of one or any combination of Examples 24-25, wherein the control signaling may be encoded for transmission in a broadcast frame.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of a station (STA), the apparatus comprising: memory; and processing circuitry, configured to:
decode control signaling that indicates a target wakeup time service period (TWT SP) for contention based access by the STA for transmission of uplink control frames, the TWT SP included in a beacon interval;
contend for access during the TWT SP;
encode an uplink control frame for transmission during the TWT SP;
refrain from contention for access outside of the TWT SP during the beacon interval;
attempt to detect trigger frames (TFs) outside of the TWT SP during the beacon interval; and
if a TF outside of the TWT SP during the beacon interval is detected, determine whether the detected TF indicates that the STA is scheduled for transmission of an uplink data frame,
wherein the memory is configured to store the TWT SP.

2. The apparatus according to claim 1, wherein the uplink control frame is a power save (PS) poll frame, a quality of service (QoS) frame or a sounding frame.

3. The apparatus according to claim 1, wherein:
if the detected TF indicates that the transmission of the uplink data frame by the STA is scheduled, the processing circuitry is further configured to encode the uplink data frame in accordance with schedule information included in the detected TF.

4. The apparatus according to claim 3, wherein the uplink data frame includes a trigger based physical layer convergence procedure protocol data unit (TB PPDU).

5. The apparatus according to claim 1, wherein:
the control signaling is received from an access point (AP) as part of a negotiation between the AP and the STA for an establishment of a plurality of TWT SPs in a plurality of beacon intervals, and
the control signaling indicates a duration of the TWT SPs, a start time of the TWT SPs or a periodicity of the TWT SPs.

6. The apparatus according to claim 5, wherein:
the TWT SP is for a TWT mode in which the contention based access is restricted outside of the TWT SP during the beacon interval, and
the processing circuitry is further configured to encode, for transmission, a high efficiency (HE) capability field that indicates whether the TWT mode is supported by the STA.

7. The apparatus according to claim 1, wherein:
the control signaling is received as part of a unilateral indication, by an access point (AP), of a plurality of TWT SPs in a plurality of beacon intervals, and
the control signaling indicates a duration of the TWT SPs, a start time of the TWT SPs or a periodicity of the TWT SPs.

8. The apparatus according to claim 1, wherein the control signaling is included in a beacon frame.

9. The apparatus according to claim 1, wherein:
the TWT SP is for a TWT mode in which the contention based access is restricted outside of the TWT SP during the beacon interval, and
the control signaling includes an indicator of whether the TWT mode is to be enabled or disabled.

10. The apparatus according to claim 1, wherein the control signaling is included in a TWT response frame, an association response, a probe response or in a basic service set (BSS) transition management frame.

11. The apparatus according to claim 1, wherein the control signaling includes a TWT flow identifier field that indicates:
a restriction for transmission outside of the TWT SP during the beacon interval, or
a restriction for transmission inside of the TWT SP during the beacon interval.

12. The apparatus according to claim 1, wherein at least a portion of the control signaling is received from an access point (AP) while the STA is unassociated with the AP.

13. The apparatus according to claim 1, wherein:
the STA is arranged to operate in accordance with a wireless local area network (WLAN) protocol, and
the contention based access includes access in accordance with an enhanced distributed channel access (EDCA) technique.

14. The apparatus according to claim 1, wherein the apparatus further includes a transceiver to receive the control signaling and to transmit the uplink data frame.

15. The apparatus according to claim 14, wherein the transceiver is configurable to receive the control signaling and to transmit the uplink data frame in a frequency band that includes 6 GHz.

16. The apparatus according to claim 1, wherein the processing circuitry includes a baseband processor to decode the control signaling.

17. A computer-readable storage medium that stores instructions for execution by one or more processors to perform operations for communication by an access point (AP), the operations to configure the one or more processors to:
encode, for transmission, control signaling to indicate that contention based access by a station (STA) in a beacon interval is restricted to a target wakeup time service period (TWT SP);
schedule an uplink transmission by the STA outside of the TWT SP during the beacon interval;
encode, for transmission, a trigger frame (TF) that indicates the scheduled uplink transmission by the STA during the beacon interval; and
decode the uplink transmission from the STA.

18. The computer-readable storage medium according to claim 17, wherein:
the control signaling is encoded for transmission as part of a negotiation between the AP and the STA for an establishment of a plurality of TWT SPs in a plurality of beacon intervals, and
the control signaling indicates a duration of the TWT SPs, a start time of the TWT SPs or a periodicity of the TWT SPs.

19. The computer-readable storage medium according to claim 17, wherein the control signaling is encoded for transmission in a broadcast frame.

20. A method of communication at a station (STA), the method comprising:
decoding control signaling that indicates a target wakeup time service period (TWT SP) of a beacon interval, wherein:
contention based access by the STA during the beacon interval is restricted to the TWT SP, and
access by the STA outside of the TWT SP during the beacon interval is restricted to scheduled access indicated by a trigger frame (TF) from an access point (AP);
contending for access during the TWT SP; and
refraining from contention for access outside of the TWT SP during the beacon interval.

21. The method according to claim 20, further comprising:
detecting a TF outside of the TWT SP during the beacon interval;
determining, based on the detected TF, if an uplink transmission is scheduled for the STA outside of the TWT SP during the beacon interval; and
if it is determined that the uplink transmission is scheduled for the STA, encoding a frame for the uplink transmission.

22. An apparatus of an access point (AP), the apparatus comprising: memory; and processing circuitry, configured to:
encode, for transmission, control signaling that indicates a target wakeup time service period (TWT SP) for contention based access for transmission of uplink control frames by a station (STA), the TWT SP included in a beacon interval;
attempt to detect an uplink control frame from the STA during the TWT SP;
encode, for transmission outside of the TWT SP during the beacon interval, a trigger frame (TF) that indicates a scheduled transmission of an uplink data frame by the STA; and
decode the uplink data frame from the STA,
wherein the memory is configured to store the TWT SP.

23. The apparatus according to claim 22, wherein:
the uplink control frame is a power save (PS) poll frame, a quality of service (QoS) frame or a sounding frame, or
the uplink data frame includes a trigger based physical layer convergence procedure protocol data unit (TB PPDU).

24. An apparatus of a station (STA), the apparatus comprising: memory; and processing circuitry, configured to:
decode a quiet time period (QTP) element that indicates one or more QTPs of a beacon interval, wherein:
the QTP element indicates a starting time of at least one of the QTPs, a duration of at least one of the QTPs and a time difference between at least two of the QTPs,
contention based access by the STA during the beacon interval is restricted to the QTPs, and
access by the STA outside of the QTPs during the beacon interval is restricted to scheduled access indicated by a trigger frame (TF) from an access point (AP);
contend for access during one of the QTPs; and
refrain from contention for access outside of the QTPs during the beacon interval,
wherein the memory is configured to store at least a portion of the QTP element.

25. The apparatus according to claim 24, the processing circuitry further configured to:
detect a TF outside of the QTPs during the beacon interval;
determine, based on the detected TF, if an uplink transmission is scheduled for the STA outside of the QTPs during the beacon interval; and
if it is determined that the uplink transmission is scheduled for the STA, encode a frame for the uplink transmission.
